(19) United States
(12) Patent Application Publication
(10) Pub. No.: US 2016/0078531 A1
(43) Pub. Date: Mar. 17, 2016

(54) AGGREGATION ENGINE FOR REAL-TIME COUNTERPARTY CREDIT RISK SCORING

(71) Applicant: International Business Machines Corporation, Armonk, NY (US)

(72) Inventors: Neil Bartlett, Toronto (CA); Robert J. Blainey, Newmarket (CA); Barnaby Dalton, Mississauga (CA); Dharmendra P. Gupta, Mississauga (CA); Mohammad Fahham A. Khan, Ancaster (CA); Louis Ly, Toronto (CA); James Sedgwick, Toronto (CA); Jan Treibig, Nurnberg (DE); Lior Velichover, North York (CA); Kai-Ting A. Wang, Vaughan (CA)

(21) Appl. No.: 14/484,110

(22) Filed: Sep. 11, 2014

(51) Int. Cl. G06Q 40/02; G06F 17/18

(52) U.S. Cl. CPC G06Q 40/025; G06F 17/18

(57) ABSTRACT

Techniques are disclosed for computing a real-time credit risk score. In one example, the method comprises at least one processor generating a computation graph comprising static computation nodes, dynamic computation nodes, and computation edges. The computation graph is a tree. Before receiving the real-time trade, the processor determines a pipeline kernel in the computation graph and computes the respective static information in the pipeline kernel. After computing the static information, the processor receives the real-time trade. The real-time trade is associated with a current exchange of assets for which a real-time credit risk score may be determined and comprises real-time information for use in computing the real-time credit risk score. The processor computes, based on the real-time trade and the computed static information, the dynamic information in the pipeline kernel and computes, based on the computed dynamic information, the real-time credit risk score.

### TECHNICAL FIELD

The disclosure relates to credit risk management systems.

### STATEMENT REGARDING PRIOR DISCLOSURES BY THE INVENTOR OR A JOINT INVENTOR

The following disclosure(s) are submitted under 35 U.S.C. 102(b)(1)(A): DISCLOSURE: “Optimizing IBM Algorithmics' Mark-to-future Aggregation Engine for Real-time Counterparty Credit Risk Scoring,” WANG et al., Nov. 18, 2013, Proceedings of the 6th Workshop on High Performance Computational Finance, 8 pp.

### BACKGROUND

Counterparty Credit Risk (CCR) is a metric used by financial institutions to evaluate the likelihood of the counterparty of a financial contract (referred to as counterparty for short) to default prior to the expiration of the contract. It is critical for a financial institution to predict the CCR of a counterparty when making a trading decision and when pricing the value of a trade. Traditionally, trades are made by human beings, and response time for CCR typically falls into the range of hundredth of milliseconds. The emergence of electronic and e-commerce trading, however, demands a much faster response time and higher throughput over the current generation of CCR software which are designed mainly for human traders. Furthermore, it is also highly desirable to improve the precision of risk computation. A CCR is more precise if its computation takes into consideration more number of market scenarios and/or involves more timesteps. All of these requirements demand highly efficient software implementations and effective utilization of hardware resources.

### SUMMARY

In one example, the disclosure is directed to a method for computing a real-time credit risk score that includes generating, by at least one processor, a computation graph comprising one or more static computation nodes, one or more dynamic computation nodes, and one or more computation edges, wherein the computation graph is a tree comprising the one or more static computation nodes and the one or more dynamic computation nodes interconnected by the one or more computation edges, wherein the one or more static computation nodes of the computation graph each contain static information, and wherein the one or more dynamic computation nodes of the computation graph each comprise dynamic information; determining, by the at least one processor and before receiving a real-time trade, a pipeline kernel in the computation graph, wherein the pipeline kernel comprises at least one of the one or more static computation nodes, at least one of the one or more dynamic computation nodes, and a path originating from one of the one or more static computation nodes or one of the one or more dynamic computation nodes along at least one of the one or more computation edges; computing, by the at least one processor and before receiving a real-time trade, the respective static information contained in each of the one or more static nodes of the pipeline kernel; after the respective static information contained in each of the one or more static nodes of the pipeline kernel is computed, receiving, by the at least one processor, the real-time trade, wherein the real-time trade is associated with a current exchange of assets for which a real-time credit risk score may be determined, and wherein the real-time trade comprises real-time information; computing, by the at least one processor and based at least in part on the real-time information in the real-time trade and the respective computed static information contained in each of the one or more static computation nodes, the respective dynamic information contained in each of the one or more dynamic computation nodes of the pipeline kernel; and computing, by the at least one processor and based at least in part on the respective computed dynamic information contained in each of the one or more dynamic computation nodes, the real-time credit risk score.

In another example, the disclosure is directed to a computing device for computing a real-time credit risk score that includes at least one processor; and one or more modules operable by the at least one processor to: generate a computation graph comprising one or more static computation nodes, one or more dynamic computation nodes, and one or more computation edges, wherein the computation graph is a tree comprising the one or more static computation nodes and the one or more dynamic computation nodes interconnected by the one or more computation edges, wherein the one or more static computation nodes of the computation graph each contain static information, and wherein the one or more dynamic computation nodes of the computation graph each comprise dynamic information; determine, before receiving a real-time trade, a pipeline kernel in the computation graph, wherein the pipeline kernel comprises at least one of the one or more static computation nodes, at least one of the one or more dynamic computation nodes, and a path originating from one of the one or more static computation nodes or one of the one or more dynamic computation nodes along at least one of the one or more computation edges; compute, before receiving a real-time trade, the respective static information contained in each of the one or more static nodes of the pipeline kernel; after the respective static information contained in each of the one or more static nodes of the pipeline kernel is computed, receive, the real-time trade, wherein the real-time trade is associated with a current exchange of assets for which a real-time credit risk score may be determined, and wherein the real-time trade comprises real-time information; compute, based at least in part on the real-time information in the real-time trade and the respective computed static information contained in each of the one or more static computation nodes of the pipeline kernel, the respective dynamic information contained in each of the one or more dynamic computation nodes of the pipeline kernel; and compute, based at least in part on the respective computed dynamic information contained in each of the one or more dynamic computation nodes, the real-time credit risk score.

In another example, the disclosure is directed to a computer-readable storage medium comprising instructions for causing at least one processor to: generate a computation graph comprising one or more static computation nodes, one or more dynamic computation nodes, and one or more computation edges, wherein the computation graph is a tree comprising the one or more static computation nodes and the one or more dynamic computation nodes interconnected by the one or more computation edges, wherein the one or more static computation nodes of the computation graph each contain static information, and wherein the one or more dynamic computation nodes of the computation graph each comprise dynamic information; determine, before receiving a real-time trade, a pipeline kernel in the computation graph, wherein the pipeline kernel comprises at least one of the one or more static computation nodes, at least one of the one or more dynamic computation nodes, and a path originating from one of the one or more static computation nodes or one of the one or more dynamic computation nodes along at least one of the one or more computation edges; compute, before receiving a real-time trade, the respective static information contained in each of the one or more static nodes of the pipeline kernel; after the respective static information contained in each of the one or more static nodes of the pipeline kernel is computed, receive, the real-time trade, wherein the real-time trade is associated with a current exchange of assets for which a real-time credit risk score may be determined, and wherein the real-time trade comprises real-time information; compute, based at least in part on the real-time information in the real-time trade and the respective computed static information contained in each of the one or more static computation nodes of the pipeline kernel, the respective dynamic information contained in each of the one or more dynamic computation nodes of the pipeline kernel; and compute, based at least in part on the respective computed dynamic information contained in each of the one or more dynamic computation nodes, the real-time credit risk score.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example Mark-to-future Aggregation engine that may compute real-time credit risk scores, according to one or more techniques of this disclosure.

FIG. 2 is a block diagram illustrating a more detailed example computing system that may compute real-time credit risk scores, according to one or more techniques of this disclosure.

FIG. 3 is a block diagram of an example computing device that may execute real-time credit risk score computation software, according to one or more techniques of this disclosure.

FIG. 4 is a flow diagram illustrating an example hierarchy graph overlaid with a computation graph, according to one or more techniques of this disclosure.

FIG. 5 is a flow diagram illustrating an example process to compute a real-time credit risk score, according to one or more techniques of this disclosure.

### DETAILED DESCRIPTION

The concept of default and its associated painful repercussions have been a particular area of focus for financial institutions, especially after the 2007/2008 global financial crisis. Counterparty credit risk (CCR), i.e. risk associated with a counterparty default prior to the expiration of a contract, has gained tremendous amount of attention which resulted in new CCR measures and regulations being introduced. In particular, users may measure the potential impact of each real time trade or potential real time trade against exposure limits for the counterparty using Monte Carlo simulations of the trade value, and also calculate the Credit Value Adjustment (i.e., how much it will cost to cover the risk of default with this particular counterparty if/when the trade is made). These rapid limit checks and CVA calculations demand more computing power from the hardware. Furthermore, with the emergence of electronic trading, the extreme low latency and high throughput real-time compute requirement push both the software and hardware capabilities to the limit. Techniques of this disclosure focus on optimizing the computation of risk measures and trade processing in Mark-to-future Aggregation (MAG) engines. Techniques of this disclosure may speed up the end-to-end trade processing based on a pre-compiled approach. The net result may provide a speed up of three to five times over the existing MAG engine using a real client workload, for processing trades which perform limit checks and CVA reporting on exposures while taking full collateral modelling into account.

The Mark-to-Future Aggregation Engine (MAG) is a key component of the risk computation software from Algorithmics that performs statistical measurements of the CCR computation. The current generation of the MAG engine was designed for human traders and sustains a throughput of 3-5 trades per second with a latency of up to 300 ms per trade. The targeted risk precision is defined in terms of 5000 market scenarios by 250 timesteps. The MAG engine is where statistical measurements for CCR such as Credit Value Adjustment (CVA) and collateral modeling are computed.

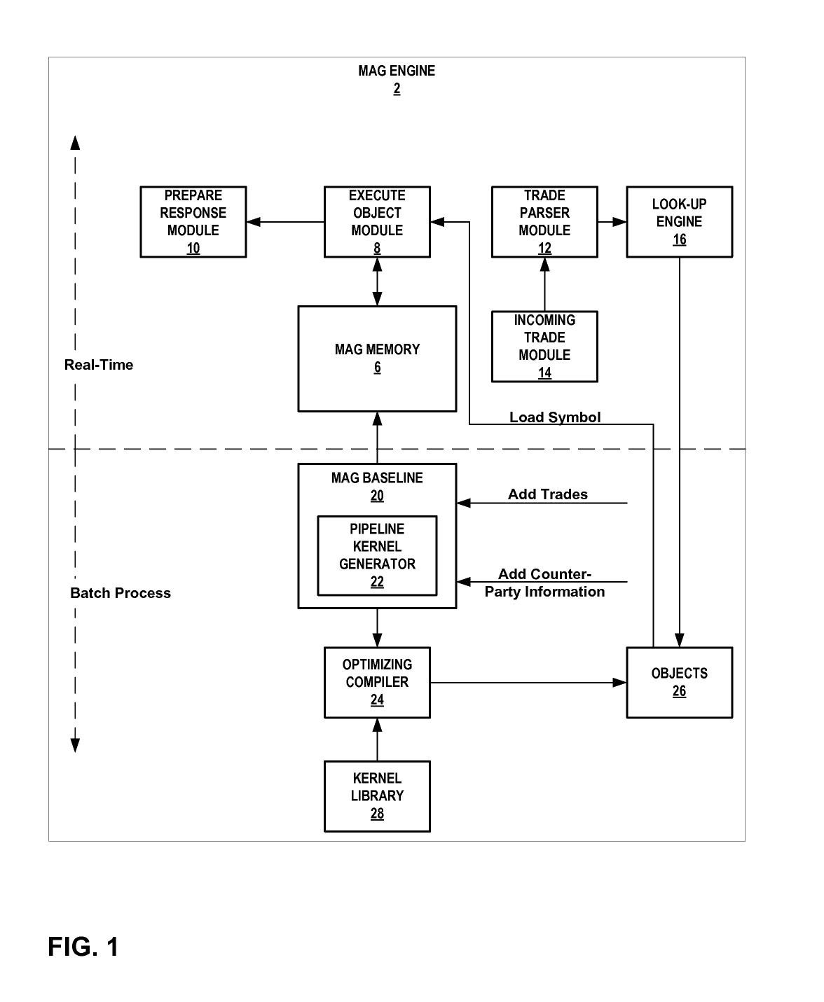

FIG. 1 is a block diagram illustrating an example Mark-to-future Aggregation engine that may compute real-time credit risk scores, according to one or more techniques of this disclosure. FIG. 1 illustrates only one particular example of Mark-to-future Aggregation (MAG) engine 2, and many other examples of MAG engine 2 may be used in other instances and may include a subset of the components included in example MAG engine 2 or may include additional components not shown in FIG. 1. For instance, MAG engine 2 can include additional components that, for clarity, are not shown in FIG. 1. As one example, MAG engine 2 can include a battery to provide power to the components of MAG engine 2.

MAG engine 2 may include a MAG memory 6 and MAG baseline 20. MAG engine 2 may also include a processor to execute one or more modules, including execute object module 8, prepare response module 10, trade parser module 12, incoming trade module 14, and look-up engine 16. MAG engine 2 may also include optimizing compiler 24, objects 26, and kernel library 28.

MAG memory 6 within MAG engine 2 may store information for processing during operation of MAG engine 2. In some examples, MAG memory 6 is a temporary memory, meaning that a primary purpose of MAG memory 6 is not long-term storage. MAG memory 6 on MAG engine 2 may configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

MAG memory 6, in some examples, also includes one or more computer-readable storage media. MAG memory 6 may be configured to store larger amounts of information than volatile memory. MAG memory 6 may, in some cases, further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. MAG memory 6 may store program instructions and/or data associated with one or more modules, including execute object module 8, prepare response module 10, trade parser module 12, incoming trade module 14, and look-up engine 16.

FIG. 1 illustrates one example of a software architecture of MAG engine 2 that implements techniques of the current disclosure. As it may, in some instances, be too time consuming to generate a pipeline kernel for an incoming trade in real time, which is handled by incoming trade module 14, MAG engine 2 generates pipeline kernels for typical trade processing ahead of time using pipeline kernel generator 22 of MAG baseline 20. In the existing MAG system, there exists a maintenance time window in which the system is brought down to perform batch processing, such as reconstructing the computation graph and re-priming the system with data according to latest trading information. While batch processing is underway, a backup MAG engine with an older baseline state may continue to handle any incoming real time trade. Techniques of this disclosure may allow a MAG engine to piggy-back on this mechanism to generate all pipeline kernels and compile them into binaries. Kernel library 28, tuned for specific architectures, may then be dynamically linked in at run time. Finally, execute object module 8 loads the symbols from the library and real-time trading is ready to begin. Once real-time trades are received by incoming trade module 14, credit-risk scores may be prepared and output by prepare response module 10.

In some examples, objects 26 may be a computation or a computer program. In other words, objects 26 may be coded objects. For example, objects 26 may be a C program where, after being compiled, is an object. In another example, objects 26 may be in binary form. In any case, objects 26 may be executed by one or more processors according to one or more techniques of this disclosure.

In certain examples, MAG engine 2 may operate on two types of graphs. The top-level graph is called a hierarchy graph, where a node may, for instances, represent a type of a financial contract, and an edge indicates the existence of some relationship between contracts. There may be one hierarchy graph for each counterparty. From the hierarchy graph, along with information on statistical measures that a client specifies to compute, a directed graph called the computation graph may be derived. There may be one computation graph for each counterparty. The computation graph may be mostly a tree, in which case it is very much like an expression tree. In a computation graph, nodes represent computations and edges represent data dependence between computations. A node may include a computation kernel and its internal data called states. States are typically vectors or dense matrices called sheets. A sheet may comprise a two-dimension data structure organized by scenarios and time points. In one example, sheets may be in memory sequentially along the scenario dimension. There are two types of nodes in a computation graph, consolidation nodes and transformation nodes. Both types of nodes may produce a new result, while only consolidation nodes may modify its own states. When applying computation from a consolidation node, states may be first read and then modified, such as element-wise summation of an incoming sheet into the sheet associated with the consolidation node. In other words, a consolidation node may be a dynamic node which modifies real-time information in a real-time trade as it is received a transformation node, on the other hand, does not modify any states, and therefore may be a static node which may be computed separately from the real-time information. On average, each computation graph may contain ten nodes. States associated with a computation graph node can be several mega-bytes.

A real-time trade may include two pieces of real-time information: a trade value sheet and trade parameters. The trade value sheet may come from the pricing engine, with simulated floating point values over a set of market scenarios and timesteps. Trade parameters may include which counterparty is trading and other information such as the maturity date of the trade. The counterparty information of trade parameters determines which computation graph to be used for trade evaluation. When evaluating a trade on a computation graph, it typically refers to the process of absorbing the trade value sheet into some consolidation nodes of the graph and/or computing statistical measures on computation graph nodes.

In some examples, a trade can be either read-only or commit. Read-only trades (e.g., what-if or lookup trades) do not modify any state of the computation graph, whereas commit trades do modify a state of the computation graph. When evaluating a trade, computation kernels associated with the computation graph may be executed in a post-fix order similar to evaluating an expression tree. A computation kernel on a consolidation node takes as input its own state, as well as the output, or states, of its children. A particular leaf node, as selected by the trade parameter, takes as input its own state and the trade sheet. This process of propagating the trade value from the leaf node up is termed contribution absorption process.

According to certain techniques of the current disclosure, before processing any real time trade, MAG engine 2 may construct all hierarchy graphs and computation graphs based on previous trades. It also may prime modifiable states of a computation graph by evaluating existing trades over the computation graph. The priming process is typically done in an overnight batch run. Once all computation graphs are primed, MAG engine 2 is said to be in a baseline state and ready to handle real time trade evaluation. Most CCR computations involve one counterparty, thus evaluation of distinct counterparties are largely independent. This gives the opportunity to perform inter-trade parallel processing. However, when multiple commit trades are against the same counterparty, potential data collision may prevent parallelization at the trade level. Techniques of this disclosure may use a subset of cores for intra trade parallel processing and may process several trades concurrently.

MAG engine 2 may be implemented in various coding languages and may be designed according to software engineering principles. The code may be highly object oriented and make extensive use of templates. As common in object-oriented codes, functions may be small in size and data structures present themselves as classes and are accessed via small access functions. The actual computations may be spread among a large amount of source code. While this modular and abstract software design is favorable from a software engineering point of view, for performance engineering it is often difficult to collect the necessary information and understand the results. The code may be mostly sequential and may hardly make use of the data parallel processing capabilities of modern processors. A positive aspect of the code may be that it utilizes simple two dimensional arrays as basic data structure enabling an efficient use of the memory hierarchy.

MAG engine 2 that executes techniques of this disclosure may define a framework that breaks down a typical risk scoring computation into basic units of computation kernels that are optimized individually. Such units of computation may be referred to as opcodes. Each opcode may be implemented as a computation kernel with a clearly defined set of input and output. As a basic computing block of a trace evaluation, each computation kernel is individually tuned. Opcodes are composed into a sequence to express the computation involved in a trade evaluation. The implementation of an opcode sequence, which may be naturally composed of kernel calls, may be referred to as a pipeline kernel. Under this framework, each node of a computation graph may be an opcode and the computation involved in evaluating a trade can be naturally expressed by a pipeline kernel consisting of computation kernels involved in a post-order traversal of the computation graph.

A pipeline kernel may be a path originating from one of the static nodes or one of the dynamic nodes in a computation graph that follows computation edges from the originating node to the root node, or the point where a credit risk score is calculated. In some computation graphs, a plurality of pipeline kernels may exist. In such a case, the pipeline kernels may be indexed for reference by look-up engine 16.

During a real time trading, trade parser module 12 parses the incoming trade and constructs the symbol name of the corresponding pipeline kernel based on the counterparty and node information. Then look-up engine 16 loads the appropriate precompiled pipeline kernel and executes it. Look-up engine 16 may select the pipeline kernel from the plurality of precompiled pipeline kernels based at least in part on the real-time information in the real-time trade. As an effective technique to reduce redundant computation, MAG engine 2 is also optimized to move computations that do not depend on any real time trade information to the batch processing. Results of pre-computation can be stored inside MAG memory 6 and used later by real-time trade processing.

Kernel library 28 may hold elementary kernels and composite kernels. Elementary kernels typically represent one type of computation and can be classified into three classes. A first class is summation-based kernels that reduce a vector into a scalar value. A second class is copy- or scale-based kernels that read one or more vectors and produces a new vector. A third class is sorting-based kernels that perform sorting. Both summation- and copy/scale-based kernels can be well optimized by the compiler and are mainly memory bandwidth limited. Sorting-based kernels are more expensive than the previous two and highly input sensitive. They are typically control-flow and instruction throughput limited. Composite kernels, on the other hand, involve different types of computation and often invoke other elementary kernels. For instance, collateral and CVA are both composite kernels. Kernels may also differ in their access patterns to sheet data structures. Most kernels iterate over the scenario dimension (also innermost dimension) of a sheet, while others traverse sheets along the time point dimension, resulting in poor spatial locality due to large strided accesses. Kernel library 28 may support all processor types and may be built from a single source code base.

There are three basic approaches to improving the latency and throughput of a software system: reducing instruction path lengths (e.g., reduce the amount of computation), improving CPI (e.g., improve core efficiency), and exploiting parallelism. In reducing computation, when implementing computational kernels, choosing efficient algorithms and data structures may minimize the amount of computation for each kernel. An important source of inefficiency in existing MAG engine implementation comes from redundant computation, such as loop invariant computation that can be hoisted out of inner loop nests. Another example to reduce computation is to pre-compute the required sequence of Gaussian random numbers, which are very expensive to generate due to its use of log/sqrt/div operations, and store them in memory. During real-time trade processing, the pre-computed random numbers are simply retrieved from memory. This optimization effectively trades-off memory for computation. Techniques of this disclosure may also employ value specialization to simplify control-flow in composite kernels, such as CVA and collateral, that use nested if statement on variables with one or only a few possible values. Code, such as a C++ template, may be used to specialize the few possible values for these variables. Each specialized code may enable the folding of some conditional statement, which in turn may enable further dead code elimination.

Other types of static information may include user configurations (which may be supplied through an incorporated text, such as an extensible markup language (XML) document), previous trading patterns (such as a hierarchical relationship), and exchange rates. For instance, a computation path in a computation graph may include a conversion from the Canadian dollar to the American dollar, followed by a conversion from the American dollar to the Australian dollar. Techniques of this disclosure may, in some examples, calculate a conversion from the Canadian dollar to the Australian dollar during a batch process where pipeline kernels are generated, allowing one extra conversion to be skipped when real-time processing is occurring.

Techniques of this disclosure may also exploit both single-instruction multiple data (SIMD) parellelism and thread-level parallelism. SIMD parallelism is exploited mostly on elementary kernels, such as summation- and scale-based kernels, which contains few control-flow and mainly contiguous memory accesses in their computation loops. While some elementary kernels can be automatically vectorized by the compiler, others may be vectorized manually using SIMD intrinsics or assembly codes. Synchronization is required after every kernel execution and the overhead can be a limiting factor for scalability. Most kernels contain outer loops over time points. The parallelism over processing a large amount of time points may be typically sufficient to achieve a good load balancing for the number of hardware threads available on a typical server.

To optimize memory hierarchy, a consideration is to traverse data in a hardware pre-fetcher friendly fashion, expose more cache locality, and employ first touch placement to benefit from the parallel memory interfaces available on current multi-socket servers. For all kernels, techniques of this disclosure may make sure that data is transferred in a stride one fashion. If a kernel accesses some sheet data in a strided fashion, spatial blocking along the scenario dimension is used to utilize prefetching capabilities and exploit spatial locality.

Finite-precision floating-point summation is a very common underlying operation for many statistical computations used in financial risk analysis. Therefore, techniques of this disclosure may employ a summation algorithm that is both fast in speed and produces an accurate result. For example, Kahan summation may be used in the Credit Value Adjustment (CVA) computation to boost the summation accuracy, while compromising on speed. This is because the Kahan summation algorithm achieves good accuracy by introducing additional arithmetic operations. As the demand for real-time CVA and aggregation rises drastically, speed or performance becomes an aspect that cannot be readily compromised. Techniques of this disclosure may include a shift-reduce summation algorithm which uses a cascading technique to sum a sequence of floating point numbers. It has the same error bound as a pairwise summation algorithm, which is an error bound proportional to log 2(N) for summing a sequence of N numbers.

There are many possible advantages of using a shift-reduce algorithm over the pairwise summation algorithms. It is non-recursive (as inspired by the concept of a shift-reduce parser) and hence avoids the overhead associated with recursion, such as that of acquiring and deleting the stack in each recursive call. The additional book keeping storage required by shift reduce is a maximum storage of 64*sizeof(float). This temporary storage can be contained in the L1 cache, or primary cache, and does not incur much load latency which means small overhead. The L1 cache may be a static memory integrated with a processor core that is used to store information recently accessed by a processor. The L1 cache may improve data access speed in cases when the CPU accesses the same data multiple times. It can be readily SIMD optimized. The SIMD optimized shift-reduce implementation has identical error bound as the non-SIMD optimized shift-reduce implementation. The shift-reduce algorithm enables a more effective SIMD optimization than the pairwise summation algorithm. This is because the prologue and epilogue handling for data misalignment are done only once, outside of the main loop body. In our kernel library the user can choose to either sacrifice some accuracy for speed and use the faster SIMD-vectorized shift-reduce kernel or use an optimized Kahan-Babuska algorithm for highest accuracy.

The tail kernel, or quantile computation, is often used in the context of computing Value-at-Risk (VaR). VaR is a widely used risk measure of the risk of a devastating loss on a specific portfolio of financial assets under some infrequent circumstance. Given a probability percentile and a particular timestep, the tail kernel, in the context of the aggregation engine, identifies which market scenario(s) would exceed, or fall below, the threshold. A commonly used statistical routine to implement the tail kernel is the std::nth_element routine. It performs a quick select operation without performing the complete quick sort. The tail kernel is parallelized along the timestep dimension. This means that doing the select operation on a vector of length 5000 is the atomic operation. Because select is not bandwidth limited and takes significant time this kernel scales very well. Due to imperfect pipelining, this kernel may also benefit from using SMT threads. The mean kernel, which does summation computation, along with the tail kernel are the two key kernels used by CVA. That is, CVA may utilize either the mean kernel, or tail kernel, as controlled by a parameter.

The collateral kernel is used to model the collateral posted to comply with a CSA (credit support annex from an International Swaps and Derivatives Association master agreement) between two counterparties. The input is the aggregated value of a set of deals that fall under the CSA. Collateral is by far the most costly kernel and a difficult optimization target because of its many configuration parameters. The collateral algorithm requires many input parameters, such as the lag periods, which are time windows between when collaterals are posted to when they are actually received. The algorithm adjusts each input value, i.e., sheet(tj,si) at a particular time j and scenario i, with collaterals that have been posted prior to tj and are received by tj. This requires taking lag periods into account. It is possible that a collateral is posted not on simulation time point (i.e. not on a defined tj) and its effect needs to be interpolated to a nearest time point. Brownian bridge interpolation is therefore used. The interpolation process requires normally distributed numbers which are typically expensive to generate as expensive operations such as log, divide and square root are needed. Other algorithms for generating normally distributed numbers may require rational polynomials. The bridge may also use expensive operations in computing the required coefficients. Three specific optimizations are applied to the collateral kernel. These are pre-computation or caching of results generated by intermediate operations, SMP parallelization, and input data transpose. Input data transpose is beneficial if a kernel accesses the data with large offsets orthogonal to the data layout in memory. The overhead introduced by the transpose operations is compensated by the more efficient data access in the kernel. An alternative to this is spatial blocking, which also improves the data access pattern for the cost of slightly bigger memory consumption for the necessary caching of intermediate results.

Different processors often require architecture specific optimizations for good performance. Because this might involve using binary incompatible SIMD instruction set extensions, a mechanism is required to support different processors and still provide architecture specific optimizations. Certain requirements may be met. One single kernel library may support all necessary processor types. The mechanism may have the ability to detect the underlying architecture and pick an optimized kernel at runtime. The mechanism may have no restrictions against supported processor microarchitectures. The mechanism may also ensure low or no overhead introduced via the mechanism.

With the above requirements, techniques of this disclosure may utilize a general adaptive mechanism for runtime kernel selection. On startup, a centralized init routine may be called once, detecting on which architecture the code is running. On X86 this stage is based on querying the cpuid instruction, which provides detailed information about supported processor features. The init routine enables the use of an optimized kernel by setting a function pointer to the proper architecture specific version. A generic portable default version is used when no architecture specific version is available. The kernel is then invoked via the function pointer during runtime of the application.

Different choices are available for providing specifically optimized kernels. An option is to use an optimizing compiler 24. To meet the portability requirement, code auto-dispatching may be used. In case compiler 24 does not support auto-dispatching, a variant build may be used. The implementing mechanism may be based on a combination of make and C preprocessor techniques and can be realized with a single source strategy. If necessary, an architecture specific kernel can also be implemented by hand using intrinsics or assembly language. Which kernel is used for a specific processor type may be explicitly set in the init routine. For every kernel, a portable fallback may be provided. This may give the library developer the flexibility of either hooking up a hand or a compiler optimized kernel into the adaptive framework. The framework also allows the use of different compilers for different processors. The overhead associated with kernel invocation via a function pointer versus direct call was evaluated using a micro benchmark. The adaptive optimization mechanism implemented simplifies the build environment as well as the library usage and execution environment as there is only one library being built from one single source code base.

In some examples, MAG engine 2 may compute a real-time credit risk score. For instance, MAG engine 2 may generate a computation graph comprising one or more static computation nodes, one or more dynamic computation nodes, and one or more computation edges. In one example, the computation graph is a tree comprising the one or more static computation nodes and the one or more dynamic computation nodes interconnected by the one or more computation edges. In some examples, the one or more static computation nodes of the computation graph each contain static information. In some examples, the one or more dynamic computation nodes of the computation graph each comprise dynamic information. MAG engine 2 may, before receiving the real-time trade, determine a pipeline kernel in the computation graph. The pipeline kernel may comprise at least one of the one or more static computation nodes, at least one of the one or more dynamic computation nodes, and a path originating from one of the one or more static computation nodes or one of the one or more dynamic computation nodes along at least one of the one or more computation edges. MAG engine 2 may compute, before receiving the real-time trade, the respective static information contained in each of the one or more static nodes of the pipeline kernel. After the respective static information contained in each of the one or more static nodes of the pipeline kernel is computed, MAG engine 2 may receive the real-time trade. In these cases, the real-time trade is associated with a current exchange of assets for which a real-time credit risk score may be determined and comprises real-time information for use in computing the real-time credit risk score. MAG engine 2 may compute, based at least in part on the real-time information in the real-time trade and the respective computed static information contained in each of the one or more static computation nodes of the pipeline kernel, the respective dynamic information contained in each of the one or more dynamic computation nodes of the pipeline kernel. MAG engine 2 may compute, based at least in part on the respective computed dynamic information contained in each of the one or more dynamic computation nodes, the real-time credit risk score.

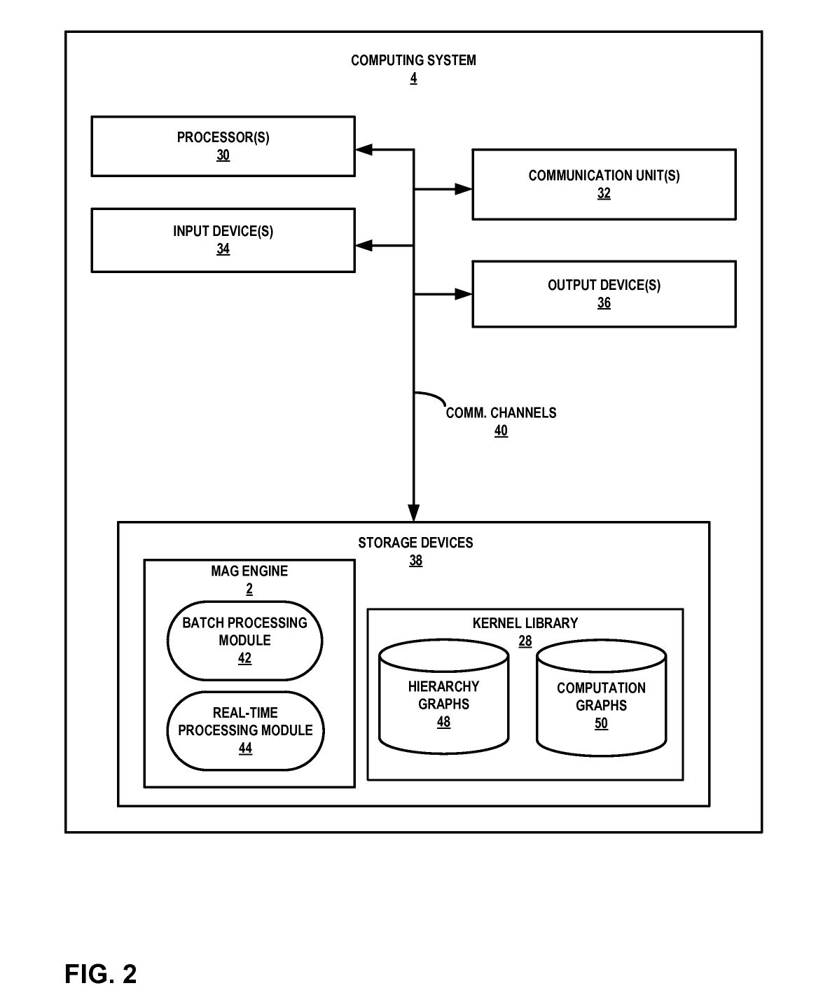

FIG. 2 is a block diagram illustrating a more detailed example of a computing system 4 that may compute real-time credit risk scores within the context of FIG. 1, according to one or more techniques of this disclosure. FIG. 2 illustrates only one particular example of computing device 4, and many other examples of computing device 4 may be used in other instances and may include a subset of the components included in example computing device 4 or may include additional components not shown in FIG. 2.

Computing device 4 can include additional components that, for clarity, are not shown in FIG. 2. For example, computing device 4 can include a battery to provide power to the components of computing device 4. Similarly, the components of computing device 4 shown in FIG. 2 may not be necessary in every example of computing device 4. For example, in some configurations, computing device 4 may not include communication unit 32.

In the example of FIG. 2, computing device 4 includes one example of MAG engine 2 shown in FIG. 1, one or more processors 30, one or more input devices 34, one or more communication units 32, one or more output devices 36, and one or more storage devices 38. Storage devices 38 of computing device 4 also include batch processing module 42, real-time processing module 44, kernel library 28, hierarchy graphs 48, and computation graphs 50. Communication channels 40 may interconnect each of the components 2, 30, 32, 34, 36, 38, 28, 42, 44, 48, and 50 for inter-component communications (physically, communicatively, and/or operatively). In some examples, communication channels 40 may include a system bus, a network connection, an inter-process communication data structure, or any other construct for communicating data.

One or more communication units 32 of computing device 4 may communicate with external devices via one or more networks by transmitting and/or receiving network signals on the one or more networks. For example, computing device 4 may use communication unit 32 to transmit and/or receive radio signals on a radio network such as a cellular radio network. Likewise, communication units 30 may transmit and/or receive satellite signals on a satellite network such as a GPS network. Examples of communication unit 32 include a network interface card (e.g. such as an Ethernet card), an optical transceiver, a radio frequency transceiver, a GPS receiver, or any other type of device that can send and/or receive information. Other examples of communication units 32 may include Bluetooth®, GPS, 3G, 4G, and Wi-Fi® radios found in mobile devices as well as Universal Serial Bus (USB) controllers.

One or more input devices 34 of computing device 4 may receive input. Examples of input are tactile, audio, visual, and video input. Input devices 34 of computing device 4, in one example, includes a mouse, keyboard, voice responsive system, video camera, microphone or any other type of device for detecting input from a human or machine. In some examples, input device 32 may be a presence-sensitive input device, which may include presence-sensitive screen, touch-sensitive screen, etc.

One or more output devices 36 of computing device 4 may generate output. Examples of output are tactile, audio, visual, and video output. Output devices 36 of computing device 4, in one example, includes a presence-sensitive screen, sound card, video graphics adapter card, speaker, cathode ray tube (CRT) monitor, liquid crystal display (LCD), or any other type of device for generating output to a human or machine. Output devices 36 may include display devices such as cathode ray tube (CRT) monitor, liquid crystal display (LCD), or any other type of device for generating visual output.

One or more storage devices 38 within computing device 4 may store information for processing during operation of computing device 4. In some examples, storage device 38 is a temporary memory, meaning that a primary purpose of storage device 38 is not long-term storage. Storage devices 38 on computing device 4 may configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage devices 38, in some examples, also include one or more computer-readable storage media. Storage devices 38 may be configured to store larger amounts of information than volatile memory. Storage devices 38 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage devices 38 may store program instructions and/or data associated with MAG engine 2, batch processing module 42, real-time processing module 44, kernel library 28, hierarchy graphs 48, and computation graphs 50. For instance, kernel library 28, similar to kernel library 28 as described with respect to FIG. 1, may store hierarchy graphs 48 and computation graphs 50 that correspond to the hierarchy graphs and computation graphs described with respect to FIG. 1.

One or more processors 30 may implement functionality and/or execute instructions within computing device 4. For example, processors 30 on computing device 4 may receive and execute instructions stored by storage devices 38 that execute the functionality of MAG engine 2, batch processing module 42, real-time processing module 44, kernel library 28, hierarchy graphs 48, and computation graphs 50. These instructions executed by processors 30 may cause computing device 4 to store information, within storage devices 38 during program execution. Processors 30 may execute instructions of MAG engine 2, batch processing module 42, real-time processing module 44, kernel library 28, hierarchy graphs 48, and computation graphs 50 to cause input device 34 to display a user interface. That is, items in storage device 38, such as batch processing module 42, real-time processing module 44, kernel library 28, hierarchy graphs 48, and computation graphs 50, may be operable by processors 30 to store information and data that may be used to perform various actions, including computing a real-time credit risk score, as shown in FIG. 1.

MAG engine 2 may include modules to execute one or more of the techniques of this disclosure. For instance, MAG engine 2 may include a batch processing module 42 and a real-time processing module 44. Batch processing module 42 may be operable by the one or more processors 30 to execute techniques of this disclosure corresponding to a batch process. For instance, batch processing module 42 may generate a computation graph comprising one or more static computation nodes and one or more dynamic computation nodes. In some examples, the one or more static computation nodes of the computation graph each contain static information that is computed before a real-time trade is received. In some examples, the one or more dynamic computation nodes of the computation graph each comprise dynamic information that uses the real-time information to be computed. In these cases, the real-time trade is associated with a current exchange of assets for which a real-time credit risk score may be determined and comprises real-time information for use in computing the real-time credit risk score. Batch processing module 42 may also compute, before receiving the real-time trade, the respective static information contained in each of the one or more static nodes of the computation graph.

Real-time processing module 44 may be operable by the one or more processors 30 to execute techniques of this disclosure corresponding to a real-time trade calculation. For instance, real-time processing module 44 may receive the real-time trade. Real-time processing module 44 may compute, based at least in part on the real-time information in the real-time trade and the respective computed static information contained in each of the one or more static computation nodes, the respective dynamic information contained in each of the one or more dynamic computation nodes of the computation graph. Real-time processing module 44 may compute, based at least in part on the respective computed dynamic information contained in each of the one or more dynamic computation nodes, the real-time credit risk score. For example, real-time processing module 44 may process dynamic information such as the maturity date of a trade or the counter-party to a trade.

In some examples, the one or more processors 30 may execute instructions for generating, by computing system 4, a computation graph comprising one or more static computation nodes, one or more dynamic computation nodes, and one or more computation edges. In one example, the computation graph is a tree comprising the one or more static computation nodes and the one or more dynamic computation nodes interconnected by the one or more computation edges. In some examples, the one or more static computation nodes of the computation graph each contain static information. In some examples, the one or more dynamic computation nodes of the computation graph each comprise dynamic information. The instructions may cause processors 30 to, before receiving the real-time trade, determine a pipeline kernel in the computation graph. The pipeline kernel may comprise at least one of the one or more static computation nodes, at least one of the one or more dynamic computation nodes, and a path originating from one of the one or more static computation nodes or one of the one or more dynamic computation nodes along at least one of the one or more computation edges. The instructions may cause processors 30 to compute, before receiving the real-time trade, the respective static information contained in each of the one or more static nodes of the pipeline kernel. After the respective static information contained in each of the one or more static nodes of the pipeline kernel is computed, the instructions may cause processors 30 to receive the real-time trade. In these cases, the real-time trade is associated with a current exchange of assets for which a real-time credit risk score may be determined and comprises real-time information for use in computing the real-time credit risk score. The instructions may cause processors 30 to compute, based at least in part on the real-time information in the real-time trade and the respective computed static information contained in each of the one or more static computation nodes, the respective dynamic information contained in each of the one or more dynamic computation nodes of the pipeline kernel. The instructions may cause processors 30 to compute, based at least in part on the respective computed dynamic information contained in each of the one or more dynamic computation nodes, the real-time credit risk score. In other examples, the one or more processors may execute other instructions in accordance with techniques of this disclosure.

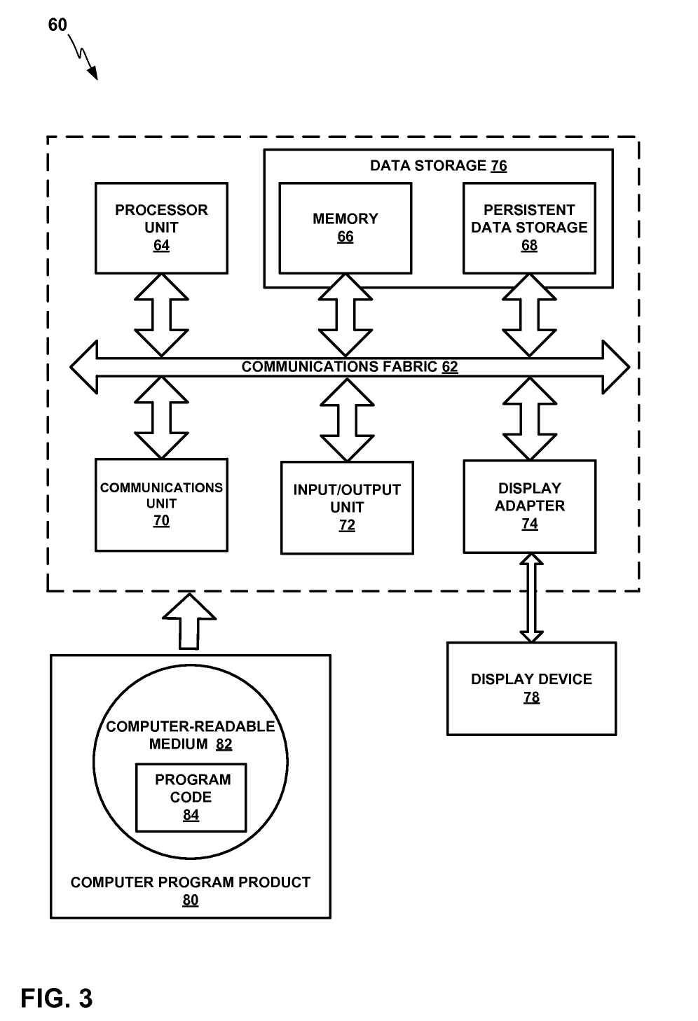

FIG. 3 is a block diagram of an example computing device that may execute real-time credit risk score computation software, according to one or more techniques of this disclosure. The real-time credit risk score computation application may enable computation of real-time credit risk scores either by incorporating this capability within a single application, or by making calls or requests to or otherwise interacting with any of a number of other modules, libraries, data access services, indexes, databases, servers, or other computing environment resources, for example. Computing device 60 may be a workstation, server, mainframe computer, notebook or laptop computer, desktop computer, tablet, smartphone, feature phone, or other programmable data processing apparatus of any kind Computing device 60 of FIG. 3 may represent any of computing system 4 as depicted in FIG. 2, for example. Other possibilities for computing device 60 are possible, including a computer having capabilities or formats other than or beyond those described herein.

In this illustrative example, computing device 60 includes communications fabric 62, which provides communications between processor unit 64, memory 66, persistent data storage 68, communications unit 70, and input/output (I/O) unit 72. Communications fabric 62 may include a dedicated system bus, a general system bus, multiple buses arranged in hierarchical form, any other type of bus, bus network, switch fabric, or other interconnection technology. Communications fabric 62 supports transfer of data, commands, and other information between various subsystems of computing device 60.

Processor unit 64 may be a programmable central processing unit (CPU) configured for executing programmed instructions stored in memory 66. In another illustrative example, processor unit 64 may be implemented using one or more heterogeneous processor systems in which a main processor is present with secondary processors on a single chip. In yet another illustrative example, processor unit 64 may be a symmetric multi-processor system containing multiple processors of the same type. Processor unit 64 may be a reduced instruction set computing (RISC) microprocessor such as a PowerPC® processor from IBM® Corporation, an x86 compatible processor such as a Pentium® processor from Intel® Corporation, an Athlon® processor from Advanced Micro Devices® Corporation, or any other suitable processor. In various examples, processor unit 64 may include a multi-core processor, such as a dual core or quad core processor, for example. Processor unit 64 may include multiple processing chips on one die, and/or multiple dies on one package or substrate, for example. Processor unit 64 may also include one or more levels of integrated cache memory, for example. In various examples, processor unit 64 may include one or more CPUs distributed across one or more locations.

Data storage 76 includes memory 66 and persistent data storage 68, which are in communication with processor unit 64 through communications fabric 62. Memory 66 can include a random access semiconductor memory (RAM) for storing application data, i.e., computer program data, for processing. While memory 66 is depicted conceptually as a single monolithic entity in FIG. 3, in various examples, memory 66 may be arranged in a hierarchy of caches and in other memory devices, in a single physical location, or distributed across a plurality of physical systems in various forms. While memory 66 is depicted physically separated from processor unit 64 and other elements of computing device 60, memory 66 may refer equivalently to any intermediate or cache memory at any location throughout computing device 60, including cache memory proximate to or integrated with processor unit 64 or individual cores of processor unit 64.

Persistent data storage 68 may include one or more hard disc drives, solid state drives, flash drives, rewritable optical disc drives, magnetic tape drives, or any combination of these or other data storage media. Persistent data storage 68 may store computer-executable instructions or computer-readable program code for an operating system, application files that include program code, data structures or data files, and any other type of data. These computer-executable instructions may be loaded from persistent data storage 68 into memory 66 to be read and executed by processor unit 64 or other processors. Data storage 76 may also include any other hardware elements capable of storing information, such as, for example and without limitation, data, program code in functional form, and/or other suitable information, either on a temporary basis and/or a permanent basis.

Persistent data storage 68 and memory 66 are examples of physical, tangible, non-transitory computer-readable data storage devices. Data storage 76 may include any of various forms of volatile memory that may require being periodically electrically refreshed to maintain data in memory, but those skilled in the art will recognize that this also constitutes an example of a physical, tangible, non-transitory computer-readable data storage device. Executable instructions are stored on a non-transitory medium when program code is loaded, stored, relayed, buffered, or cached on a non-transitory physical medium or device, including if only for only a short duration or only in a volatile memory format.

Processor unit 64 can also be suitably programmed to read, load, and execute computer-executable instructions or computer-readable program code for a real-time credit risk score computation application, as described in greater detail above. This program code may be stored on memory 66, persistent data storage 68, or elsewhere in computing device 60. This program code may also take the form of program code 84 stored on computer-readable medium 82 that is included in computer program product 80, and may be transferred or communicated, through any of a variety of local or remote means, from computer program product 80 to computing device 60 to be enabled to be executed by processor unit 64, as further explained below.

The operating system may provide functions such as device interface management, memory management, and multiple task management. The operating system can be a Unix based operating system such as the AIX® operating system from IBM® Corporation, a non-Unix based operating system such as the Windows® family of operating systems from Microsoft® Corporation, a network operating system such as JavaOS® from Oracle® Corporation, a mobile device operating system such as iOS® from Apple® Inc., or any other suitable operating system. Processor unit 64 can be suitably programmed to read, load, and execute instructions of the operating system.

Communications unit 70, in this example, provides for communications with other computing or communications systems or devices. Communications unit 70 may provide communications through the use of physical and/or wireless communications links. Communications unit 70 may include a network interface card for interfacing with a network 6, an Ethernet adapter, a Token Ring adapter, a modem for connecting to a transmission system such as a telephone line, or any other type of communication interface. Communications unit 70 can be used for operationally connecting many types of peripheral computing devices to computing device 60, such as printers, bus adapters, and other computers. Communications unit 70 may be implemented as an expansion card or be built into a motherboard, for example.

The input/output unit 72 can support devices suited for input and output of data with other devices that may be connected to computing device 60, such as keyboard, a mouse or other pointer, a touchscreen interface, an interface for a printer or any other peripheral device, a removable magnetic or optical disc drive (including CD-ROM, DVD-ROM, or Blu-Ray), a universal serial bus (USB) receptacle, or any other type of input and/or output device. Input/output unit 72 may also include any type of interface for video output in any type of video output protocol and any type of monitor or other video display technology, in various examples. It will be understood that some of these examples may overlap with each other, or with example components of communications unit 70 or data storage 76. Input/output unit 72 may also include appropriate device drivers for any type of external device, or such device drivers may reside in the operating system or elsewhere on computing device 60 as appropriate.

Computing device 60 also includes a display adapter 74 in this illustrative example, which provides one or more connections for one or more display devices, such as display device 78, which may include any of a variety of types of display devices, including a display screen for displaying a user interface for a real-time credit risk score computation application. It will be understood that some of these examples may overlap with example components of communications unit 70 or input/output unit 72. Input/output unit 72 may also include appropriate device drivers for any type of external device, or such device drivers may reside in the operating system or elsewhere on computing device 60 as appropriate. Display adapter 74 may include one or more video cards, one or more graphics processing units (GPUs), one or more video-capable connection ports, or any other type of data connector capable of communicating video data, in various examples. Display device 78 may be any kind of video display device, such as a monitor, a television, or a projector, in various examples.

Input/output unit 72 may include a drive, socket, or outlet for receiving computer program product 80, which includes a computer-readable medium 82 having computer program code 84 stored thereon. For example, computer program product 80 may be a CD-ROM, a DVD-ROM, a Blu-Ray disc, a magnetic disc, a USB stick, a flash drive, or an external hard disc drive, as illustrative examples, or any other suitable data storage technology. Computer program code 84 may include a real-time credit risk score computation application, as described above.

Computer-readable medium 82 may include any type of optical, magnetic, or other physical medium that physically encodes program code 84 as a binary series of different physical states in each unit of memory that, when read by computing device 60, induces a physical signal that is read by processor 64 that corresponds to the physical states of the basic data storage elements of storage medium 82, and that induces corresponding changes in the physical state of processor unit 64. That physical program code signal may be modeled or conceptualized as computer-readable instructions at any of various levels of abstraction, such as a high-level programming language, assembly language, or machine language, but ultimately constitutes a series of physical electrical and/or magnetic interactions that physically induce a change in the physical state of processor unit 64, thereby physically causing processor unit 64 to generate physical outputs that correspond to the computer-executable instructions, in a way that modifies computing device 60 into a new physical state and causes computing device 60 to physically assume new capabilities that it did not have until its physical state was changed by loading the executable instructions included in program code 84.

In some illustrative examples, program code 84 may be downloaded or otherwise accessed over a network to data storage 76 from another device or computer system, such as a server, for use within computing device 60. Program code 84 that includes computer-executable instructions may be communicated or transferred to computing device 60 from computer-readable medium 82 through a hard-line or wireless communications link to communications unit 70 and/or through a connection to input/output unit 72. Computer-readable medium 82 that includes program code 84 may be located at a separate or remote location from computing device 60, and may be located anywhere, including at any remote geographical location anywhere in the world, and may relay program code 84 to computing device 60 over any type of one or more communication links, such as the Internet and/or other packet data networks. The program code 84 may be transmitted over a wireless Internet connection, or over a shorter-range direct wireless connection such as wireless LAN, Bluetooth™, Wi-Fi™, or an infrared connection, for example. Any other wireless or remote communication protocol may also be used in other implementations.

The communications link and/or the connection may include wired and/or wireless connections in various illustrative examples, and program code 84 may be transmitted from a source computer-readable medium 82 over non-tangible media, such as communications links or wireless transmissions containing the program code 84. Program code 84 may be more or less temporarily or durably stored on any number of intermediate tangible, physical computer-readable devices and media, such as any number of physical buffers, caches, main memory, or data storage components of servers, gateways, network nodes, mobility management entities, or other network assets, en route from its original source medium to computing device 60.

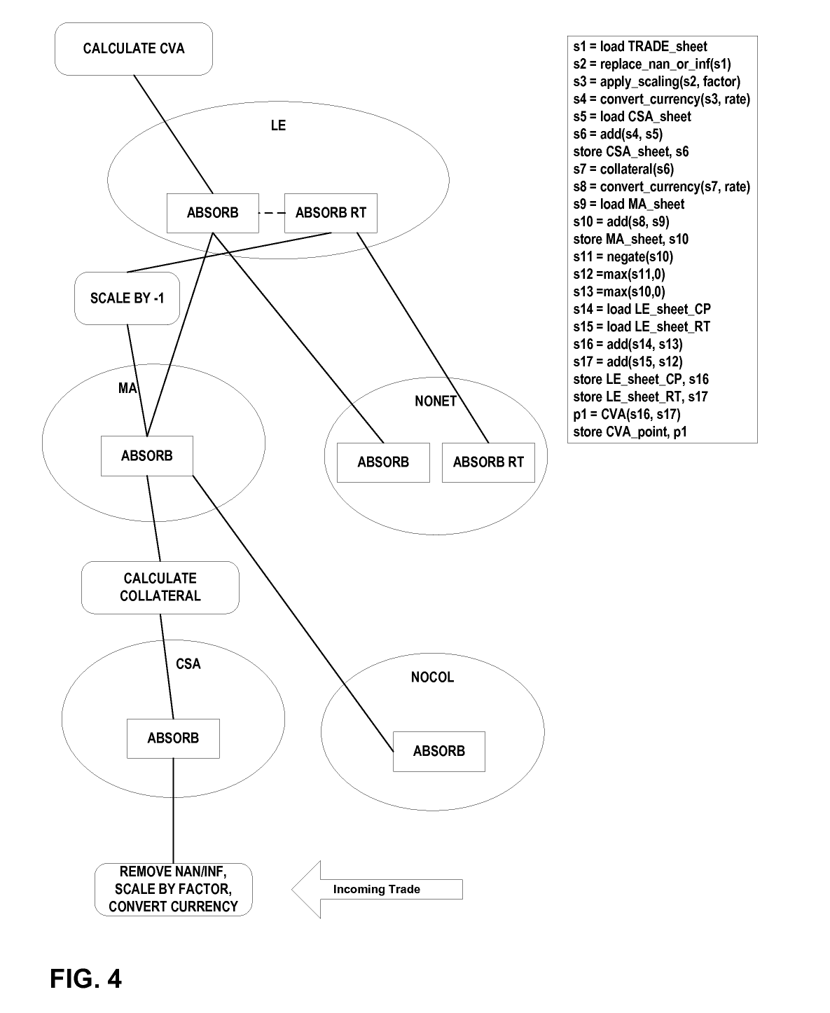

FIG. 4 is a flow diagram illustrating an example hierarchy graph overlaid with a computation graph, according to one or more techniques of this disclosure. FIG. 4 shows an example list of instructions, or a particular pipeline kernel, that may be dispatched and executed by MAG engine 2 in calculating credit risk scores for a real-time trade. This pipeline kernel path shown in FIG. 4 contains many instructions including calculating CVA and collateral. The determination of which computation path to dispatch and execute may be done by a module such as look-up engine 16 of FIG. 1 and the determination is based on real-time information in a real-time trade such as names of the counterparties and the hierarchical nodes (e.g. MA/CSA). In FIG. 4, the rounded rectangles are equivalent to the transformation nodes, and the squared rectangles are equivalent to the consolidation nodes. They are the nodes of the computation graph.

The consolidation nodes may be stateful nodes and therefore, during a batch process executed by MAG baseline 20 of FIG. 1, all the existing trades traverse the graph, and execute the instructions as described by the transformation and consolidation nodes, and modify the states of the consolidation nodes accordingly. The final effect is a computation graph with consolidation nodes primed with correct and up-to-date data, ready for real-time trading. All the possible computation paths, such the one shown in FIG. 4, are enumerated by pipeline kernel generator 22 of FIG. 1. Each computation path contains list of instructions, and is compiled by optimizing compiler 24, resulting in an object file 26, ready to be dispatched and executed. During the actual real-time trading, a desired pipeline kernel object, or computation path is then dispatched and executed.

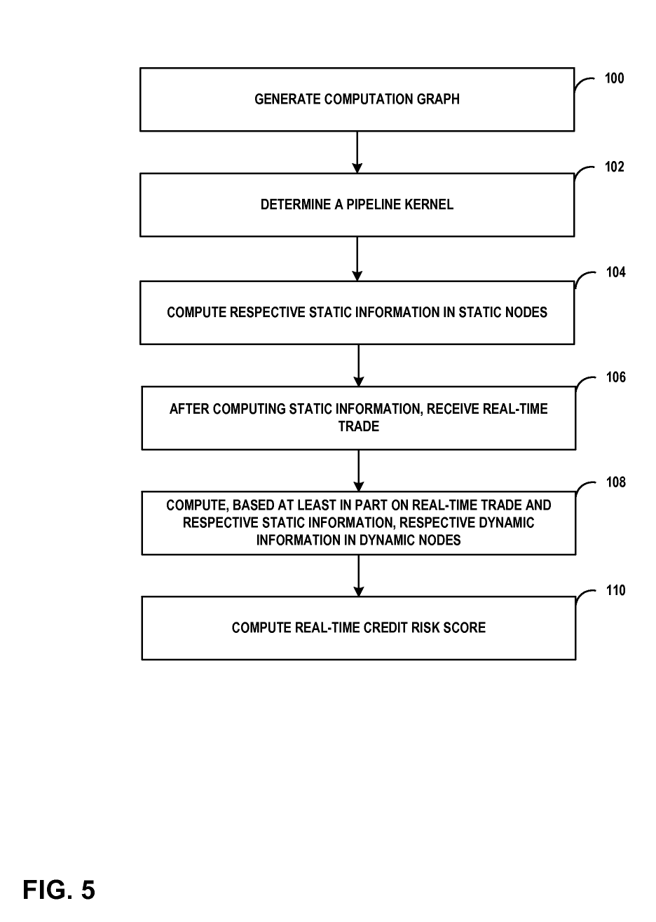

FIG. 5 is a flow diagram illustrating an example process to compute a real-time credit risk score, according to one or more techniques of this disclosure. A computing system, such as computing system 4, may perform these techniques using various components, such as the one or more processors 30 and components of MAG engine 2, such as batch processing module 42 and real-time processing module 44. In this example, MAG engine 2 may perform the actions to compute a real-time credit risk score. For instance, batch processing module 42 of MAG engine 2 may generate a computation graph (e.g., computation graph 50 of FIG. 2) comprising one or more static computation nodes, one or more dynamic computation nodes, and one or more computation edges (100). In one example, the computation graph is a tree comprising the one or more static computation nodes and the one or more dynamic computation nodes interconnected by the one or more computation edges.

In some examples, the one or more static computation nodes of the computation graph each contain static information. Examples of static information could include Gaussian random number generation, user configurations (which may be supplied through an incorporated text, such as an XML document describing the desired credit risk scores to be computed, e.g. Mean, Tail, or CVA.), previous trading patterns (such as a hierarchical relationship), and exchange rates. For instance, a computation path in a computation graph may include a conversion from the Canadian dollar to the American dollar, followed by a conversion from the American dollar to the Australian dollar. Techniques of this disclosure may calculate a conversion from the Canadian dollar to the Australian dollar during a batch process where pipeline kernels are generated, allowing one extra conversion to be skipped when real-time processing is occurring. Optimizing a pipeline kernel, or a computation path, is possible because all the instructions for a real-time trade processing are present. The conversion elimination technique described here may be accomplished by optimizing compiler 24, as shown in FIG. 1, or by pipeline kernel generator 22, as shown in FIG. 1. Applying optimizations either via the usage of a compiler, or as an additional smart in the pipeline kernel generator, result in a lean and efficient pipeline kernel object that can be dispatched and executed during real-time. In some examples, the one or more dynamic computation nodes of the computation graph each comprise dynamic information. For example, real-time processing module 44 may consume dynamic information such as the maturity date of a trade or the counter-parties involved in a trade.

Batch processing module 42 of MAG engine 2 may determine, before receiving the real-time trade, a pipeline kernel in the computation graph (102). In some examples, the pipeline kernel comprises at least one of the one or more static computation nodes, at least one of the one or more dynamic computation nodes, and a path originating from one of the one or more static computation nodes or one of the one or more dynamic computation nodes along at least one of the one or more computation edges. In some examples, MAG engine 2 may determine a plurality of pipeline kernels, with each pipeline kernel comprising at least one of the one or more static computation nodes, at least one of the one or more dynamic computation nodes, and a distinct path originating from one of the one or more static computation nodes or one of the one or more dynamic computation nodes along at least one of the one or more computation edges. In these examples, MAG engine 2 may index each of the plurality of pipeline kernels. Further, batch processing module 42 of MAG engine 2 may compute, before receiving the real-time trade, the respective static information contained in each of one or more static nodes of the plurality of pipeline kernels.

In some examples, generating the computation graph may include the MAG engine 2 generating a plurality of computation graphs each comprising one or more static computation nodes and one or more dynamic computation nodes. In this example, each of the one or more static computation nodes of each of the computation graphs contain static information that is computed before the real-time trade is received. Also, each of the one or more dynamic computation nodes of each of the computation graphs comprise dynamic information that uses the real-time information to be computed. In this example, MAG engine 2 may determine a plurality of pipeline kernels for each of the plurality of computation graphs. Further, batch processing module 42 of MAG engine 2 may compute, before receiving the real-time trade, the respective static information contained in each of one or more static nodes of each of the plurality of pipeline kernels. In some examples, batch processing module 42 of MAG engine 2 may index, before receiving the real-time trade, the plurality of pipeline kernels (in, e.g., kernel library 28 of FIGS. 1 and 2). MAG engine 2 may then, after receiving the real-time trade, select the pipeline kernel from the plurality of pipeline kernels. The selecting is based on the real-time information contained in the real-time trade. In some of these examples, each of the plurality of computation graphs is associated with a distinct counterparty.

In some examples, generating the computation graph may be based at least in part on a hierarchy graph (e.g., hierarchy graphs 48 of FIG. 2). In these examples, batch processing module 42 of MAG engine 2 may further generate a hierarchy graph comprising a plurality of nodes and a plurality of edges. Each node of the plurality of nodes represents a financial contract, and each edge of the plurality of edges connects two or more nodes and represents a relationship between the two or more nodes it connects.

Batch processing module 42 of MAG engine 2 may compute, before receiving the real-time trade, the respective static information contained in each of the one or more static nodes of the pipeline kernel (104). In some examples, batch processing module 42 may determine an ordered list of one or more opcodes for the pipeline kernel corresponding to each of the one or more static nodes and each of the one or more dynamic nodes of the pipeline kernel. In these examples, batch processing module 42 may then determine whether any opcodes in the ordered list of one or more opcodes can be executed based on the respective static information in each of the one or more static nodes of the pipeline kernel. In response to determining that at least one opcode in the ordered list of one or more opcodes can be executed, batch processing module 42 may execute, based at least in part on the respective static information in each of the one or more static nodes of the pipeline kernel, the at least one opcode.

After the respective static information contained in each of the one or more static nodes of the pipeline kernel is computed, real-time processing module 44 of MAG engine 2 may receive the real-time trade (106). In these cases, the real-time trade is associated with a current exchange of assets for which a real-time credit risk score may be determined and comprises real-time information for use in computing the real-time credit risk score. In some examples, the real-time information in the real-time trade comprises a two-dimensional data structure representing a plurality of scenarios and a plurality of time points. Real-time processing module 44 of MAG engine 2 may compute, based at least in part on the real-time information in the real-time trade and the respective computed static information contained in each of the one or more static computation nodes of the pipeline kernel, the respective dynamic information contained in each of the one or more dynamic computation nodes of the pipeline kernel (108).

Real-time processing module 44 of MAG engine 2 may compute, based at least in part on the respective computed dynamic information contained in each of the one or more dynamic computation nodes, the real-time credit risk score (110). In some examples, the real-time credit risk score comprises a credit value adjustment and an exposure limit for a counterparty. In these examples, MAG engine 2 may further compute the exposure limit for the counterparty using Monte Carlo simulations of a trade value.

As will be appreciated by a person skilled in the art, aspects of the present disclosure may be embodied as a method, a device, a system, or a computer program product, for example. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer-readable data storage devices or computer-readable data storage components that include computer-readable medium(s) having computer readable program code embodied thereon. For example, a computer-readable data storage device may be embodied as a tangible device that may include a tangible data storage medium (which may be non-transitory in some examples), as well as a controller configured for receiving instructions from a resource such as a central processing unit (CPU) to retrieve information stored at one or more particular addresses in the tangible, non-transitory data storage medium, and for retrieving and providing the information stored at those particular one or more addresses in the data storage medium.

The data storage device may store information that encodes both instructions and data, for example, and may retrieve and communicate information encoding instructions and/or data to other resources such as a CPU, for example. The data storage device may take the form of a main memory component such as a hard disc drive or a flash drive in various embodiments, for example. The data storage device may also take the form of another memory component such as a RAM integrated circuit or a buffer or a local cache in any of a variety of forms, in various embodiments. This may include a cache integrated with a controller, a cache integrated with a graphics processing unit (GPU), a cache integrated with a system bus, a cache integrated with a multi-chip die, a cache integrated within a CPU, or the computer processor registers within a CPU, as various illustrative examples. The data storage apparatus or data storage system may also take a distributed form such as a redundant array of independent discs (RAID) system or a cloud-based data storage service, and still be considered to be a data storage component or data storage system as a part of or a component of an embodiment of a system of the present disclosure, in various embodiments.

Any combination of one or more computer readable medium(s) may be utilized. The computer readable medium may be a computer readable signal medium or a computer readable storage medium. A computer readable storage medium may be, for example, but is not limited to, a system, apparatus, or device used to store data, but does not include a computer readable signal medium. Such system, apparatus, or device may be of a type that includes, but is not limited to, an electronic, magnetic, optical, electromagnetic, infrared, electro-optic, heat-assisted magnetic, or semiconductor system, apparatus, or device, or any suitable combination of the foregoing. A non-exhaustive list of additional specific examples of a computer readable storage medium includes the following: an electrical connection having one or more wires, a portable computer diskette, a hard disc, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device, for example.

Program code embodied on a computer readable medium may be transmitted using any appropriate medium, including but not limited to radio frequency (RF) or other wireless, wire line, optical fiber cable, etc., or any suitable combination of the foregoing. Computer program code for carrying out operations for aspects of the present invention may be written in any combination of one or more programming languages, including an object oriented programming language such as Java, Smalltalk, C++, or the like, or other imperative programming languages such as C, or functional languages such as Common Lisp, Haskell, or Clojure, or multi-paradigm languages such as C#, Python, or Ruby, among a variety of illustrative examples. One or more sets of applicable program code may execute partly or entirely on the user's desktop or laptop computer, smartphone, tablet, or other computing device; as a stand-alone software package, partly on the user's computing device and partly on a remote computing device; or entirely on one or more remote servers or other computing devices, among various examples. In the latter scenario, the remote computing device may be connected to the user's computing device through any type of network, including a local area network (LAN) or a wide area network (WAN), or the connection may be made to an external computer (for example, through a public network such as the Internet using an Internet Service Provider), and for which a virtual private network (VPN) may also optionally be used.

In various illustrative embodiments, various computer programs, software applications, modules, or other software elements may be executed in connection with one or more user interfaces being executed on a client computing device, that may also interact with one or more web server applications that may be running on one or more servers or other separate computing devices and may be executing or accessing other computer programs, software applications, modules, databases, data stores, or other software elements or data structures. A graphical user interface may be executed on a client computing device and may access applications from the one or more web server applications, for example. Various content within a browser or dedicated application graphical user interface may be rendered or executed in or in association with the web browser using any combination of any release version of HTML, CSS, JavaScript, XML, AJAX, JSON, and various other languages or technologies. Other content may be provided by computer programs, software applications, modules, or other elements executed on the one or more web servers and written in any programming language and/or using or accessing any computer programs, software elements, data structures, or technologies, in various illustrative embodiments.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Aspects of the present invention are described herein with reference to flowchart illustrations and/or block diagrams of methods, apparatus, systems, and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, may create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational acts to be performed on the computer, other programmable apparatus or other devices, to produce a computer-implemented process such that the instructions that execute on the computer or other programmable apparatus provide or embody processes for implementing the functions or acts specified in the flowchart and/or block diagram block or blocks.

The flowchart and block diagrams in the figures illustrate the architecture, functionality, and operation of possible implementations of devices, methods and computer program products according to various embodiments of the present disclosure. In this regard, each block in the flowchart or block diagrams may represent a module, segment, or portion of code, which includes one or more executable instructions for implementing the specified logical function(s). It should also be noted that, in some implementations, the functions noted in the block may occur out of the order noted in the figures. For example, two blocks shown in succession may, in fact, be executed substantially concurrently, or the blocks may be executed in a different order, or the functions in different blocks may be processed in different but parallel processing threads, depending upon the functionality involved. Each block of the block diagrams and/or flowchart illustration, and combinations of blocks in the block diagrams and/or flowchart illustration, may be implemented by special purpose hardware-based systems that perform the specified functions or acts, or combinations of executable instructions, special purpose hardware, and general-purpose processing hardware.

The description of the present disclosure has been presented for purposes of illustration and description, and is not intended to be exhaustive or limited to the disclosure in the form disclosed. Many modifications and variations will be understood by persons of ordinary skill in the art based on the concepts disclosed herein. The particular examples described were chosen and disclosed in order to explain the principles of the disclosure and example practical applications, and to enable others of ordinary skill in the art to understand the disclosure for various embodiments with various modifications as are suited to the particular use contemplated. The various examples described herein and other embodiments are within the scope of the following claims.

1-11. (canceled)

12. A computing device for computing a real-time credit risk score, the computing device comprising:
at least one processor; and
one or more modules operable by the at least one processor to:
generate a computation graph comprising one or more static computation nodes, one or more dynamic computation nodes, and one or more computation edges, wherein the computation graph is a tree comprising the one or more static computation nodes and the one or more dynamic computation nodes interconnected by the one or more computation edges, wherein the one or more static computation nodes of the computation graph each contain static information, and wherein the one or more dynamic computation nodes of the computation graph each comprise dynamic information;
determine, before receiving a real-time trade, a pipeline kernel in the computation graph, wherein the pipeline kernel comprises at least one of the one or more static computation nodes, at least one of the one or more dynamic computation nodes, and a path originating from one of the one or more static computation nodes or one of the one or more dynamic computation nodes along at least one of the one or more computation edges;
compute, before receiving a real-time trade, the respective static information contained in each of the one or more static nodes of the pipeline kernel;
after the respective static information contained in each of the one or more static nodes of the pipeline kernel is computed, receive, the real-time trade, wherein the real-time trade is associated with a current exchange of assets for which a real-time credit risk score may be determined, and wherein the real-time trade comprises real-time information;
compute, based at least in part on the real-time information in the real-time trade and the respective computed static information contained in each of the one or more static computation nodes of the pipeline kernel, the respective dynamic information contained in each of the one or more dynamic computation nodes of the pipeline kernel; and
compute, based at least in part on the respective computed dynamic information contained in each of the one or more dynamic computation nodes, the real-time credit risk score.

13. The computing device of claim 12, wherein the one or more modules are further operable by the at least one processor to:
determine a plurality of pipeline kernels, wherein each pipeline kernel of the plurality of pipeline kernels comprises at least one of the one or more static computation nodes, at least one of the dynamic computation nodes, and a distinct path originating from one of the one or more static computation nodes or one of the one or more dynamic computation nodes along at least one of the one or more computation edges;
index each of the plurality of pipeline kernels;
compute, before receiving the real-time trade, the respective static information contained in each of one or more static nodes of the plurality of pipeline kernels; and
select, after the real-time trade is received, one of the plurality of pipeline kernels based at least in part on the real-time information in the real-time trade.

14. The computing device of claim 13, wherein the one or more modules are further operable by the at least one processor to:
generate a plurality of computation graphs each comprising one or more static computation nodes, one or more dynamic computation nodes, and one or more computation edges;
determine, before the real-time trade is received, a plurality of pipeline kernels in each of the plurality of computation graphs; and
compute, before receiving the real-time trade, the respective static information contained in each of the one or more static nodes of each of the computation graphs.

15. The computing device of claim 11, wherein the real-time credit risk score comprises a credit value adjustment and an exposure limit for a counterparty.

16. The computing device of claim 15, wherein the one or more modules are further operably by the at least one processor to compute the exposure limit for the counterparty using Monte Carlo simulations of a trade value.

17. The computing device of claim 1, wherein the one or more modules are further operably by the at least one processor to:
generate a hierarchy graph comprising a plurality of nodes and a plurality of edges, wherein each node of the plurality of nodes represents a financial contract and wherein each edge of the plurality of edges connects two or more nodes and represents a relationship between the two or more nodes it connects,
wherein generating the computation graph comprises the one or more modules being operable by the at least one processor to generate, based at least in part on the hierarchy graph, the computation graph.

18. A computer-readable storage medium comprising instructions for causing at least one processor to:
generate a computation graph comprising one or more static computation nodes, one or more dynamic computation nodes, and one or more computation edges, wherein the computation graph is a tree comprising the one or more static computation nodes and the one or more dynamic computation nodes interconnected by the one or more computation edges, wherein the one or more static computation nodes of the computation graph each contain static information, and wherein the one or more dynamic computation nodes of the computation graph each comprise dynamic information;
determine, before receiving a real-time trade, a pipeline kernel in the computation graph, wherein the pipeline kernel comprises at least one of the one or more static computation nodes, at least one of the one or more dynamic computation nodes, and a path originating from one of the one or more static computation nodes or one of the one or more dynamic computation nodes along at least one of the one or more computation edges;
compute, before receiving a real-time trade, the respective static information contained in each of the one or more static nodes of the pipeline kernel;
after the respective static information contained in each of the one or more static nodes of the pipeline kernel is computed, receive, the real-time trade, wherein the real-time trade is associated with a current exchange of assets for which a real-time credit risk score may be determined, and wherein the real-time trade comprises real-time information;
compute, based at least in part on the real-time information in the real-time trade and the respective computed static information contained in each of the one or more static computation nodes of the pipeline kernel, the respective dynamic information contained in each of the one or more dynamic computation nodes of the pipeline kernel; and
compute, based at least in part on the respective computed dynamic information contained in each of the one or more dynamic computation nodes, the real-time credit risk score.

19. The computer-readable storage medium of claim 18, wherein the instructions further cause the one or more processors to:
determine a plurality of pipeline kernels, wherein each pipeline kernel of the plurality of pipeline kernels comprises at least one of the one or more static computation nodes, at least one of the dynamic computation nodes, and a distinct path originating from one of the one or more static computation nodes or one of the one or more dynamic computation nodes along at least one of the one or more computation edges;
index each of the plurality of pipeline kernels;
compute, before receiving the real-time trade, the respective static information contained in each of one or more static nodes of the plurality of pipeline kernels; and
select, after the real-time trade is received, one of the plurality of pipeline kernels based at least in part on the real-time information in the real-time trade.

20. The computer-readable storage medium of claim 18, wherein the instructions further cause the one or more processors to:
generate a hierarchy graph comprising a plurality of nodes and a plurality of edges, wherein each node of the plurality of nodes represents a financial contract and wherein each edge of the plurality of edges connects two or more nodes and represents a relationship between the two or more nodes it connects,
wherein generating the computation graph comprises the one or more modules being operable by the at least one processor to generate, based at least in part on the hierarchy graph, the computation graph.
